(19) United States
(12) Patent Application Publication
(10) Pub. No.: US 2013/0258644 A1
(43) Pub. Date: Oct. 3, 2013

(54) SAFETY GLOVE

(71) Applicants: Sal COMUNALE, Harrison, NY (US); Harry OTTO, Harrison, NY (US)

(72) Inventors: Sal COMUNALE, Harrison, NY (US); Harry OTTO, Harrison, NY (US)

(73) Assignee: OttoCom LLC, Harrison, NY (US)

(21) Appl. No.: 13/432,188

(22) Filed: Mar. 28, 2012

(51) Int. Cl. F21V 33/00

(52) U.S. Cl. 362/103

(57) ABSTRACT

A glove that comprises a main body and a plurality of finger portions that extend from the main body. The main body includes a palm portion and a wrist portion. A lamp coupled to the main body wherein the lamp is configured to disorient a human or animal. At least first and second contact sensors are disposed on first and second finger portions, respectively. A power source is electrically connected to each of the lamp and the first and second contact sensors, wherein when the first and second contact sensors are in contact, power is provided to the lamp from the power source, thereby lighting the lamp, and when the first and second contact sensors are disengaged, no power is provided to the lamp.

### FIELD OF THE INVENTION

The present invention relates to a safety glove for disorienting an assailant or aggressive animal. More particularly, the present invention relates to a glove that includes at least one lamp that lights upon activation of one or more sensors on the glove.

### BACKGROUND OF THE INVENTION

Service men and women, such as police officers and military personnel, encounter assailants in the line of duty. Such assailants often attack without warning, thereby surprising the police officer or military person. Aggressive animals can also attack without warning. Although many police officers and military personnel are highly trained, any delay in reacting to an assailant could mean injury or death and failure to capture the assailant or aggressive animal. Also, people, such as walkers, joggers, and hikers can be confronted by assailants or animals, like an unleashed dog.

Therefore, a need exists for a way to immediately disorient and neutralize an assailant or aggressive animal, particularly in a surprise attack.

### SUMMARY OF THE INVENTION

The present invention provides a glove that comprises a main body and a plurality of finger portions that extend from the main body. The main body includes a palm portion and a wrist portion. The glove includes at least one lamp. The lamp is configured to disorient a human or animal. At least first and second contact sensors are disposed on first and second finger portions, respectively. A power source is electrically connected to each lamp and the first and second contact sensors, wherein when the first and second contact sensors are in contact, power is provided to the lamp from the power source, thereby lighting the lamp, and when the first and second contact sensors are disengaged, no power is provided to the lamp. In a preferred embodiment, a controller is provided that is electrically connected to the first and second contact sensors, the lamp and the power source.

The present invention may also provide a glove that comprises a main body and a plurality of finger portions that extend from the main body. A lamp is coupled to the main body. At least first and second contact sensors disposed on the first and second finger portions of the plurality of finger portions, respectively. A controller is electrically connected to the lamp and each of the first and second contact sensors. The controller includes a flashing strobe timer circuit. A power source is electrically connected to the controller, wherein when the first and second contact sensors are in contact, power is provided to the lamp from the power source, thereby lighting the lamp, and when the first and second contact sensors are disengaged, no power is provided to the lamp. In a preferred embodiment, the lamp is an LED or a matrix of LEDs.

The present invention may further provide a glove that comprises a main body and a plurality of finger portions that extend from the main body. The plurality of finger portions include at least a thumb portion, an index finger portion, and a middle finger portion. A lamp is coupled to the main body of the glove. The lamp is configured to disorient a human or animal. First, second, and third contact sensors are disposed on the thumb portion, the index finger portion, and the middle finger portion, respectively. A controller is electrically connected to the lamp and each of the first, second, and third contact sensors. A power source is electrically connected to the controller, wherein when the first and second contact sensors are in contact, the controller provides power to the lamp so that the lamp lights with a first lighting effect, and when the first and third contact sensors are in contact, the controller provides power to the lamp so that the lamp lights with a second lighting effect that is different than the first lighting effect. In one embodiment, the first lighting effect is a strobe effect and the second lighting effect is constant light. In another embodiment, the first lighting effect is constant light and the second lighting effect is a strobe effect. In one embodiment, the strobe effect flash rate effective to cause disorientation is between about 1 and about 20 Hertz (flashes per second), preferably between about 9 and about 15 Hertz. Such flash rate may be effective to cause the Bucha effect in an assailant, causing disorientation and/or vertigo and/or nausea. The flash rate may be varied by the user (i.e. wearer of the glove 100) in order to regulate the level of discomfort caused to an assailant.

The present invention may still further provide a glove that comprises a main body and a plurality of finger portions that extend from the main body. A lamp is coupled to the main body of the glove. The lamp is configured to disorient a human or animal. A controller is electrically connected to the lamp. The controller includes a movement sensor that is activated upon a recognized motion pattern or position of the glove. A power source is electrically connected to the controller, wherein when the movement sensor recognizes the motion pattern or position of the glove, the controller provides power to the lamp, thereby lighting said lamp.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of a safety glove in accordance with an exemplary embodiment of the invention, showing the glove prior to activation of a lamp incorporated into the glove;

FIG. 2 is a perspective view of the safety glove similar to FIG. 1, except showing the glove after activation of the lamp;

FIG. 3 is a plan view of an exemplary lamp of the safety glove illustrated in FIGS. 1 and 2; and

FIG. 4 is a schematic view of an exemplary controller of the safety glove illustrated in FIGS. 1 and 2.

### DETAILED DESCRIPTION OF THE EXEMPLARY EMBODIMENTS

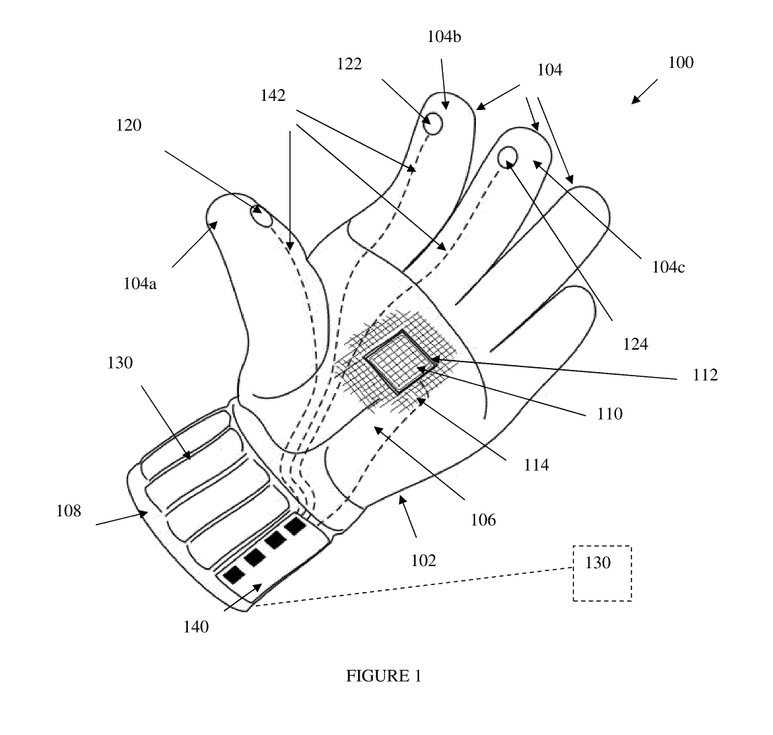

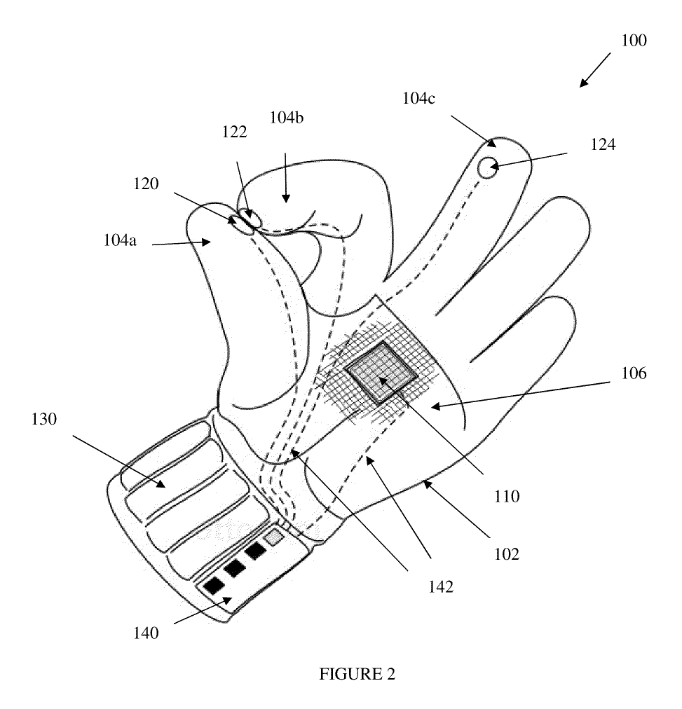

Referring to FIGS. 1-4, the present invention relates to a safety glove 100 that incorporates at least one lamp 110, such as a light emitting diode (LED), configured to provide light quickly, particularly in surprise situations, so as to disorient an assailant or aggressive animal. The lamp 110 is preferably designed to penetrate the assailant's eyelids so even if the assailant closes his eyes, the glove will still incapacitate the assailant. The lamp 110 of the present invention lights easily and quickly upon activation of one or more sensors in the glove 100. For example, a user (i.e. wearer of the glove 100) may activate the lamp 110 by touching contacts together, such as contact sensors 120, 122, and 124, that are located on finger portions of the glove, as seen in FIG. 2. Thus, a police officer or military person can immediately activate the lamp and shine the same into an assailant's eyes to disorient and neutralize the assailant. In a preferred embodiment, the light from the lamp strobes to incapacitate the assailant. In one embodiment, the strobe effect flash rate is between about 1 and about 20 Hertz (flashes per second), preferably between about 9 and about 15 Hertz. Such flash rate may be effective to cause the Bucha effect in an assailant, causing disorientation and/or vertigo and/or nausea. The flash rate may be varied by the user (i.e. wearer of the glove 100) in order to regulate the level of discomfort caused to an assailant. The present invention also provides a more humane way of controlling animals by using blinding light as compared to the traditional methods of macing, shooting, use of a stun gun, air taser or similar high voltage disabling device.

As seen in FIG. 1, the glove 100 includes a main body 102 and finger portions 104 extending from the main body 102. The finger portions 104 include at least a thumb portion 104a, an index finger portion 104b, and a middle finger portion 104c. The main body 102 may include a palm portion 106 and a wrist portion 108. The glove 100 may be made of any known glove material, such as fabric and plastic. Preferably, the material is not electrically conductive, may be heat resistant to prevent heat transfer to the user's hand, and may be waterproof. Exemplary materials of the glove may include, but are not limited to, vinyl, leather, polyester, cordura, HYVAT, GORE-TEX, ripstop, nylon, cotton, and the like. The glove 100 may also be either light or heavy weight depending on the use of the glove.

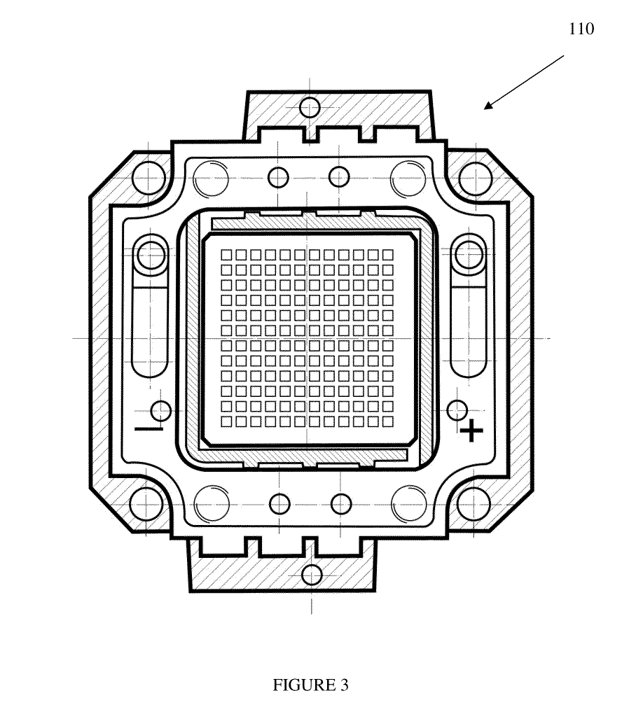

The lamp 110 may be any type of light that can be incorporated into the glove 100. Preferably, the lamp 110, when activated, causes disorientation when directed towards a person or animal. In a preferred embodiment, the lamp 110 is an LED or a matrix of LEDs, and more preferably an LED in wafer form, as seen in FIG. 3. The LED wafer element may be a compact multi LED enclosure IC similar to those used in street lamps and flood lights. Also, more than one lamp may be used on the glove 100.

The lamp 110 may be from about 20 to about 200 watts, preferably 50 watts (about 4000 lumen). At the time of the present application, current technologies allow for the manufacture of LED lamps capable of over 230 lumens per watt. This ratio of light output to wattage required has more than doubled in the last 4 years and is expected to continue increasing. A protective refractor lens may be added to the lamp that would direct the light pattern to a specified angle, increasing the lumen value and providing additional protection for the lamp. The lamp 110 may also be different colors and/or patterns. A red LED, for example, would be particularly useful for law enforcement and traffic control applications. A Red Green Blue (RGB) LED may be used that allows the user to switch between emitting a number of different colors. Various patterns may also be provided on the lamp 110 such that the lamp 110 displays a selected pattern. For example, a pattern in the form of the word STOP may be provided on the lamp 110 so that the word STOP, in English or a foreign language, is displayed when the lamp 110 is activated. A pattern, such as traffic sign like an eight sided stop sign, may be displayed. Such a symbol would be particularly useful when there may be a language barrier, such as a solider in a foreign country needing to get cars to stop at checkpoints.

Although the LED wafer 110 is shown as having a substantially square shape, the lamp 110 may have any shape, such as circular, triangular, and diamond or may be custom molded to maximize palm surface area. The lamp 110 may also be a bright light, such as a 100 watt (about 10,000 lumen) light, that is particularly useful for law enforcement and military personnel, for example, for blinding an aggressor from increased distances using wider, more forgiving dispersion patterns requiring less aim and user expertise than would normally be required by using handheld flashlight style strobe disorienting devices. By using a lamp or lamps capable of thousands of lumens requires less aim and skill and will completely disorient an aggressor. Other examples of lamps may include standard 3, 5, 8 or 10 mm raw LED elements mounted on a flexible fabric that forms the glove, preferably between 100 to 250 pcs. Organic LED elements may also be used to allow for maximum palm surface area coverage and pliability. Organic LED elements would also allow the glove to be very flexible.

The LED wafer 110 may be supported on the glove 100 in any known manner, such as by being sewn in, adhered thereto, and the like. In a preferred embodiment, the LED wafer 110 is supported in a clear flexible pocket 112 attached to the glove 100, such as at the palm portion 106, as seen in FIG. 1, which allows the light of the LED to shine therethrough. Alternatively, the lamp 110 may be secured to the glove 100 by clamping a plastic housing to the glove material and snapping the lamp into place from the rear. An optional metal screen 114 may be provided to act as a mounting support and to dissipate heat away from the LED 110. In that case, the back of the LED 110 would be fused to the metal screen 114 and the screen 114 would then be attached to the glove's main body 102. Although the lamp 110 is preferably located in the palm portion 106 of the glove's main body 102, as seen in FIG. 1, the lamp 110 may be located anywhere on the glove 100, including the finger portions.

Contact sensors 120, 122 and 124 may be provided on the glove, such as the finger portions 104 of the glove 100. Preferably, the contact sensors 120, 122 and 124 are disposed on the thumb portion 104a, the index finger portion 104b, and the middle finger portion 104c, respectively, as seen in FIGS. 1 and 2. The contact sensors 120, 122 and 124 are preferably conductive material attached to the outside of the glove, preferably at the finger portions 104. For example, as seen in FIGS. 1 and 2, the contact sensors 120, 122 and 124 may be small metal pads attached to the thumb, index finger, and middle finger portions 104a, 104b and 104c, respectively. The contact sensors 120, 122 and 124 are positioned on the glove 100 so that the user can readily and easily touch the contact sensors 120, 122 and 124 together, as seen in FIG. 2. The contact sensors 120, 122 and 124 can be used to turn the lamp 110 on, off, or to change light modes, colors, or effects, e.g. strobe effect or constant light effect.

A power source 130 for the lamp 110 may be provided either on the glove 100 or remote from the glove 100, such as on the belt of the user (shown in dashed lines in FIG. 1). In a preferred embodiment, the wrist portion 108 of the glove's main body 102 is configured to support the power source 130, which may be a battery pack or cells that are preferably rechargeable. The batteries may be compartmentalized to provide flexibility and prevent acid leakage. The batteries are preferably disposed in a spaced arrangement around the wrist portion 108 to provide flexibility to the wrist portion 108. The power source 130 may be one or more flexible solar panels. Alternatively, the glove 100 may be provided with a plug (and associated cable) for connecting to a power source.

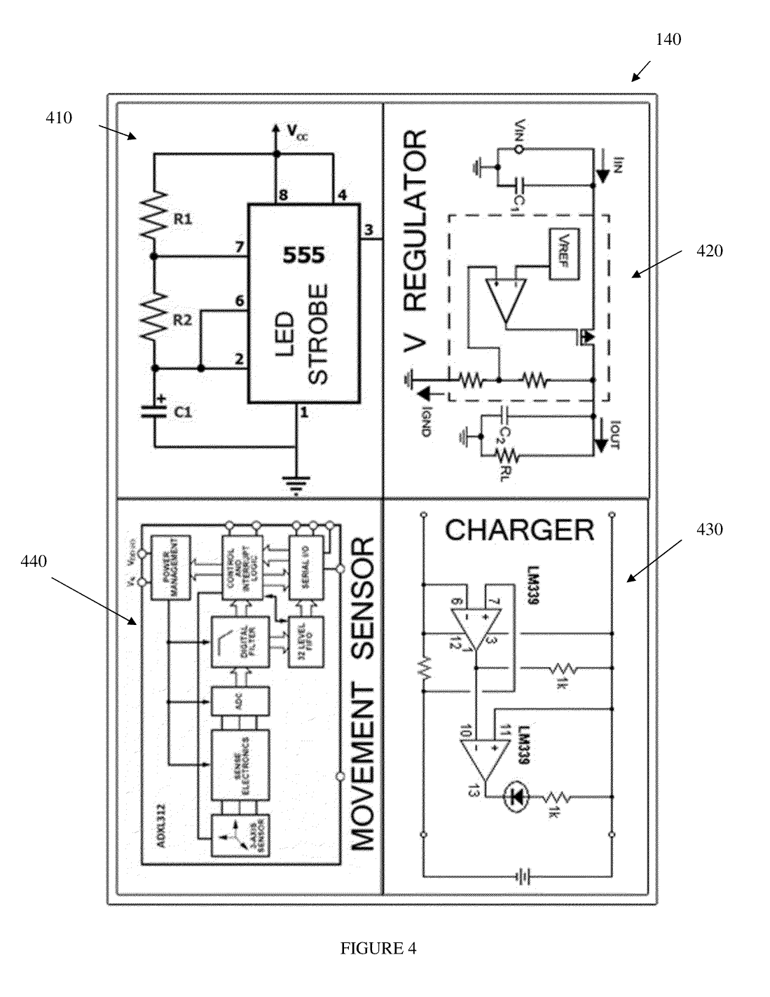

An electronic control unit or controller 140 is provided that electrically connects the contact sensors 120, 122 and 124 and the lamp 110 to the power source 130 and controls the operation of the lamp 110. The controller 140 is preferably supported in the wrist portion 108 of the glove 100. The controller 140 is connected to the power source 130 and is coupled to the contact sensors 120, 122 and 124 and the lamp 110 by conductors, such as copper wires 142. The controller 140, as seen in FIG. 4, may include a flashing strobe timer circuit 410 for a strobe effect, a voltage regulator 420, and a power source charger circuit 430. The controller 140 may include a timed latch circuit, such as a three second latch circuit, so that the user is not required to hold the contact sensors together the entire time to light the lamp. The controller 140 may also provide multi-use and multi-function intelligent switching. For example, the controller may include the ability to touch the contact sensors once for a strobe effect and touch again (double tap) to either cut-off the strobe or trigger the light in half intensity “always on” mode. The flashing strobe timer circuit may provide different flash rates based on the aggressor, e.g. whether the aggressor is an animal or a human. The controller 140 may record light patterns, motion, time, and location using a GPS. The controller may also provide a wifi cell connection. Although use of the controller 140 is preferred, the controller 140 may be eliminated such that sensors 120, 122 and 124 and the lamp 110 are directly connected to the power source, such as when the lamp 110 has a low wattage. To help prevent accidental activation of the lamp and to preserve battery life, the controller may include the ability to turn the glove on by holding the contact sensors together (e.g., for 5 seconds) before actually activating the lamp.

In accordance with another embodiment of the invention, the controller may include a movement sensor 440 (FIG. 4) that triggers the lamp 110 upon a recognized motion pattern or position of the glove. The movement sensor 440 may be a tilt sensor, such a three-axis accelerometer or simple mercury style tilt switch, that can learn movement. That is, the sensor 440 may differentiate between the motion of a user simply raising their hand versus the motion pattern of a user raising their hand and flipping their wrist, for example. Based on the motion pattern or position of the user raising their hand and flipping their wrist, such as done by a traffic officer signaling a motorist to stop, the sensor 440 activates the lamp 110. Although it is preferable to use the movement sensor 440 in addition to the contact sensors 120, 122, and 124, the glove 100 may be activated using only the sensor 440 without the contact sensors 120, 122 and 124.

In operation, when a user requires light quickly, the user simply touches the contact sensor 120 on the glove's thumb portion 104a with the contact sensor 122 on the index finger portion 104b, as seen in FIG. 2, to activate the lamp 110. The contact between the sensors 120 and 122 closes or completes the circuit to the power source 130 through the controller 140, thereby providing power to the lamp 110 and lighting the lamp 110. Releasing or separating the contacts sensors 120 and 122 opens or breaks the circuit to the power source 130 and turns off the lamp 110. Lighting effects, such as a strobe effect (i.e. light on and off) may be provided by the controller 140. The strobe effect may be triggered by contacting the contact sensors 120 and 122 of the thumb and index finger portions 104a and 104b or the lamp 110 may be activated without the strobe effect (i.e. constant light) by contacting the contact sensors 120 and 124 of the thumb and middle finger portions 104a and 104c. That is, the user has the option of lighting the lamp 110 with or without the strobe effect by touching either the contact sensor 122 or the contact sensor 124 to the thumb contact sensor 120. Another example may be touching the index contact sensor 122 and the thumb contact sensor 120 may trigger the lamp 110 to emit a red STOP signal light and touching the middle contact sensor 124 to the thumb sensor 120 may trigger a yellow SLOW DOWN light. Thus, different finger arrangements can provide different lighting effects. Such light effects can be programmed into the controller 140.

While particular embodiments have been chosen to illustrate the invention, it will be understood by those skilled in the art that various changes and modifications can be made therein without departing from the scope of the invention as defined in the appended claims. For example, the safety glove 100 may be used by anyone needing light particularly for defensive purposes, such as, joggers, hikers, etc. The glove can also provide the location of the user by the GPS of the controller. Also, although the glove 100 of the present invention is described as being used in a safety application, the glove 100 can be used for other applications including a non-safety application.

What is claimed is:

1. A glove, comprising:
a main body and a plurality of finger portions extending from said main body, said main body including a palm portion and a wrist portion;
a lamp coupled to said main body, said lamp being configured to disorient a human or animal;
at least first and second contact sensors disposed on first and second finger portions of said plurality of finger portions, respectively; and
a power source electrically connected to each of said lamp and said first and second contact sensors, wherein when said first and second contact sensors are in contact, power is provided to said lamp from said power source, thereby lighting said lamp, and when said first and second contact sensors are disengaged, no power is provided to said lamp.

2. A glove according to claim 1, further comprising
a controller electrically coupled to said power source, said lamp, and said first and second contact sensors.

3. A glove according to claim 2, wherein
said controller includes a flashing strobe timer circuit.

4. A glove according to claim 2, wherein
said controller includes at least one of a charger, a voltage regulator, and a gps.

5. A glove according to claim 2, further comprising
conductors coupling said lamp and said first and second contact sensors to said controller.

6. A glove according to claim 2, wherein
said lamp is at least 100 watts.

7. A glove according to claim 2, wherein
said controller includes a movement sensor.

8. A glove according to claim 1, wherein
each of said first and second contact sensors is conductive material attached to said first and second finger portions, respectively.

9. A glove according to claim 1, wherein
said lamp is an LED.

10. A glove according to claim 9, wherein
said LED is in the form of a wafer.

11. A glove according to claim 9, wherein
said LED is at least 50 watts.

12. A glove according to claim 1, wherein
said power source is one or more batteries.

13. A glove according to claim 12, wherein
said one or more batteries are located on said wrist portion of said main body.

14. A glove according to claim 1, wherein
said power source is located remote from the glove.

15. A glove according to claim 1, wherein
said lamp is located on said palm portion of said main body.

16. A glove, comprising:
a main body and a plurality of finger portions extending from said main body;
a lamp coupled to said main body;
at least first and second contact sensors disposed on said first and second finger portions of said plurality of finger portions, respectively;
a controller electrically connected to said lamp and each of said first and second contact sensors, said controller include a flashing strobe timer circuit; and
a power source electrically connected to said controller,
wherein when said first and second contact sensors are in contact, power is provided to said lamp from said power source, thereby lighting said lamp, and when said first and second contact sensors are disengaged, no power is provided to said lamp.

17. A glove according to claim 16, wherein
said lamp is an LED.

18. A glove according to claim 16, wherein
said controller includes one of a charger, a voltage regulator, or a gps.

19. A glove, comprising:
a main body and a plurality of finger portions extending from said main body, said plurality of finger portions including at least a thumb portion, an index finger portion, and a middle finger portion;
a lamp coupled to said main body of said glove, said lamp being configured to disorient a human or animal;
first, second, and third contact sensors disposed on said thumb portion, said index finger portion, and said middle finger portion, respectively; and
a controller electrically connected to said lamp and each of said first, second, and third contact sensors; and
a power source electrically connected to said controller,
wherein when said first and second contact sensors are in contact, said controller provides power to said lamp so that said lamp lights with a first lighting effect and when said first and third contact sensors are in contact, said controller provides power to said lamp so that said lamp lights with a second lighting effect that is different from said first lighting effect.

20. A glove according to claim 19, wherein
said first lighting effect is a strobe effect and said second lighting effect is constant light.

21. A glove according to claim 19, wherein
said first lighting effect is a colored light and said second lighting effect is colored light that is different than the first lighting effect.

22. A glove according to claim 19, wherein
said lamp is an LED.

23. A glove according to claim 22, wherein
said LED is in the form of a wafer.

24. A glove according to claim 19, wherein
conductors connect said lamp and each of said first, second and third contact sensors to said controller.

25. A glove according to claim 19, wherein
said controller includes a flashing strobe timer circuit.

26. A glove according to claim 25, wherein
said controller includes a voltage regulator and a power source charger circuit.

27. A glove according to claim 19, wherein
said power source is one or more batteries, said one or more batteries are disposed on a wrist portion of said main body.

28. A glove according to claim 19, wherein
said main body has a palm portion and a wrist portion, said lamp is disposed on said palm portion of said main body.

29. A glove, comprising:
a main body and a plurality of finger portions extending from said main body;
a lamp coupled to said main body of said glove;
a controller electrically connected to said lamp, said controller including a movement sensor, said movement sensor being activated upon a recognized motion pattern or position of the glove; and
a power source electrically connected to said controller,
wherein when said movement sensor recognizes said motion pattern or position of the glove, said controller provides power to said lamp, thereby lighting said lamp.

30. A glove according to claim 29, wherein
said lamp is an LED.

31. A glove according to claim 30, wherein
said LED is in the form of a wafer.

32. A glove according to claim 29, wherein
said controller includes a flashing strobe timer circuit, a voltage regulator, and a power source regulator.

33. A glove according to claim 29, wherein
said lamp is at least 100 watts configured to disorient a person.

34. A glove according to claim 29, wherein
said power source is one or more batteries, said one or more batteries are disposed on said main body.

35. A glove according to claim 29, wherein
said main body has a palm portion and a wrist portion, said lamp is disposed on said palm portion of said main body.

36. A glove according to claim 29, wherein
said lamp is one of 3, 5, 8 or 10 mm raw LED elements or organic LED elements.
